(19) United States
(12) Patent Application Publication
(10) Pub. No.: US 2023/0180834 A1
(43) Pub. Date: Jun. 15, 2023

(54) Heating Elements for an Aerosol Generating Device

(71) Applicant: JT International SA, Geneva (CH)

(72) Inventor: Claude Zominy, Copponex (FR)

(73) Assignee: JT International SA, Geneva (CH)

(21) Appl. No.: 17/925,452

(22) PCT Filed: May 26, 2021
(86) PCT No.: PCT/IB2021/054576

§ 371 Date: Nov. 15, 2022

(30) Foreign Application Priority Data
May 28, 2020 (EP) 20177028.6

(51) Int. Cl. A24F 40/46; A24F 40/10; A24F 40/42; A24F 40/485; A24F 40/57

(52) U.S. Cl. CPC A24F 40/46; A24F 40/10; A24F 40/42; A24F 40/485; A24F 40/57

(57) ABSTRACT

A heating element (1) for an aerosol generating device, the heating element comprising a heating body (10) extending from a first end (10a) to a second end (10b) and provided with at least first and second electric contact parts (12, 13) wherein the eating body (10) is plate-shaped and comprises an opening (11) forming a substantially central airflow passage in the plate-shaped body (10); wherein the heating element is configured to provide a heating gradient between an outer periphery of the plate-shaped body (10) and the opening (11) therein; wherein the heating element further comprises a mesh material (14) on at least one side of the plate-shaped body (10). A thickness of the plate-shaped body measured in a transversal cross-section thereof perpendicular to sides of the plate-shaped body is variable from the outer periphery of the plate to the opening, and gradually diminishes between the outer periphery and the opening.

### TECHNICAL FIELD

The present disclosure relates generally to aerosol or vapor generating systems and devices, more particularly to aerosol or vapor generating devices with consumable articles such as removable capsules or other liquid-containing devices for removable connection to an aerosol or vapor generating device.

### BACKGROUND

The use of aerosol generating systems and devices, also known as e-cigarettes, e-cigs (EC), electronic nicotine delivery systems (ENDS), electronic non-nicotine delivery systems (ENNDS), electronic smoking devices (ESDs), personal vaporizers (PV), inhalation devices, vapes, which can be used as an alternative to conventional smoking articles such as lit-end cigarettes, cigars, and pipes, is becoming increasingly popular and widespread. The most commonly used e-cigarettes are usually battery powered and use a resistance heating element to heat and atomize a liquid containing nicotine (also known as e-cigarette liquid, e-cig liquids, e-liquid, juice, vapor juice, smoke juice, e-juice, e-fluid, vape oil), to produce a condensation aerosol (often called vapor) which can be inhaled by a user.

These e-cigarettes are known in the art and on a general level they comprise a mouthpiece arranged in fluid communication with a cartridge, inserted in the mouthpiece or an e-cigarette body to which the mouthpiece is connectable. A heating element is further arranged in an airflow path between an outlet of an e-liquid chamber in the cartridge and the mouthpiece to allow vaporization of the e-liquid contained in the chamber into an aerosol. The heating element may be arranged in connection with the body of the e-cigarette or in the cartridge itself and is designed to be electrically connected in use to a power supply or source. Control circuits, sensors and/or switches may also be provided for an improved control of the e-cigarette and its power/heating management.

Various heating element arrangements are known from the prior art for such aerosol generating systems. Most commonly found heating elements comprise resistive elements such as metal wire coils, which heat upon electrical connection to up to 450° C. to generate an aerosol. These heating elements are cheap and easy to implement but do not allow proper control of the heating temperature of the e-liquid.

Beyond wire coils, more sophisticated resistive heating elements comprising laminar components have also been proposed in the prior art. US 2017/0333650 describes for example an elongated heating element formed by a resistive lamella extending longitudinally in a cartridge parallel to an airflow path of the cartridge.

Such elongated heating elements however present several weaknesses, such as a long form factor due to the length of the heating element needed to generate a sufficient amount of vapor/aerosol or a vapor/aerosol composed of larger droplets as condensation will occur along the elongated air path. Furthermore, it proves difficult to adjust the aerosol temperature along the air flow channel, for example to provide temperature gradients over the length of the heating element in order to improve aerosol formation and/or reduce condensation and potential leakage from the cartridges/devices. All these limitations have an impact on the consumer satisfaction from a sensory perspective.

### SUMMARY

It is an aim of the present invention to improve the known aerosol generating devices, and in particular to provide an alternative solution for a heating element for such devices, which does not suffer the disadvantages of the prior art and offer improved heating control and performances for improved users' experience.

On a general level, the invention provides a plate-shaped, preferably disc-shaped heating element for an aerosol-generating device such as an e-cigarette or an aerosol-generating consumable article or the like, which is configured to allow gradient heating of a vaporizable material delivered from a vaporizable material reservoir to a heating surface of the heating element. The heating element is such that the heating surface is arranged in use substantially perpendicular to an air flow channel in the aerosol generating device or article, i.e. the larger surfaces of the plate-shaped heating element are positioned to block the airflow, and the air flow passes through an opening of the heating element, for example a central opening. The plate-shaped heating element is preferably configured to carry a mesh on at least one of its surfaces. The vaporizable material may wick from the reservoir to the heating surface of the plate-shaped heating element through the mesh material, for example by capillarity, and is then evaporated by the heat generated through the plate-shaped heating element. The mesh element may be attached to the plate-shaped heating element by means of crimping ears or other equivalent means such as clips. The plate-shaped element may preferably be realized as a C-shaped disc element, the extremities of which forming and/or bearing electrical contacts. A heat gradient may be achieved in radial direction of the C-shaped disc element, therewith enabling a selective evaporation of substance provided in the vaporizable material.

In embodiments, the present invention concerns a heating element for an aerosol generating device, the heating element comprising a heating body extending from a first end to a second end and provided with at least first and second electric contact parts wherein the heating body is plate-shaped and comprises an opening forming a substantially central airflow passage in the plate-shaped body. The heating element is configured to provide a heating gradient between an outer periphery of the plate-shaped body and the opening therein and the heating element further comprises a mesh material on at least one side of the plate-shaped body. A thickness of the plate-shaped body measured in a transversal cross-section thereof perpendicular to sides of the plate-shaped body is variable from the outer periphery of the plate to the opening, and gradually diminishes between the outer periphery and the opening.

The temperature is of the heating element is proportional to the current distribution. For example, the range may be fixed, for example from 30° C. to 250° C., or the range may be based on the evaporation temperature of the vaporizable material as maximal temperature to avoid overheating the vaporizable material in contact with the mesh. For example, the range may start at 60° C. and go up to this evaporation temperature. Accordingly, a temperature gradient will be about 170° C. to 200° C. Of course, other values may be possible depending on the conditions and the vaporizable material.

In embodiments the disc plate comprises means for holding the mesh material. Such means may for example be ears, lugs or clips etc. or a combination thereof.

In embodiments the plate-shaped body is a disc.

The thickness profile of the disc plate may diminish to reach a sharp end or a flat end.

In embodiments, a largest dimension of the opening of the heating element is at most equal to a width of the plate-shaped body, said width being measured from the outer periphery to an outer edge of the opening in a direction passing through the centre of the opening.

In embodiments the disc plate is made for example of metal material and the mesh material is made for example of sintered or non-sintered metal fiber material or other porous materials The disc plate material and mesh material must resist to typical temperatures used to vaporize e-liquid, i.e., should not deform. Materials for the disc plate should be conductive and have a resistance as appropriate for implementing the heating with the current source available according to the principles of the present invention. Typical non-limiting illustrative examples of materials are Nickel, Nichrome, Kanthal, Tungsten, stainless steel, and/or alloys of these materials.

In embodiments the invention concerns a consumable article for an aerosol generating device, the article comprising a reservoir for a vaporizable material, the reservoir having a material outlet, at least one heating element as defined in present application to heat vaporizable material exiting the reservoir through the reservoir outlet to form an aerosol, and an airflow channel having an air inlet and an outlet for the aerosol generated through heating of the vaporizable material, wherein the heating element is arranged with respect to the reservoir outlet and airflow channel such that vaporizable material exiting through the reservoir outlet permeates through the mesh material towards the outer periphery of the plate-shaped body and the airflow channel passes through the opening in the plate-shaped body.

In embodiments the article comprises at least two heating elements arranged in series along a common longitudinal axis passing through the centre of each of the openings, wherein each plate-shaped body of said heating elements is configured to provide a different heating temperature.

In embodiments of the article each plate-shaped body has a different thickness and/or a different profile in the transversal cross-section.

In embodiments the said vaporizable material comprise e-liquid and/or wax and/or gel.

In embodiments the present invention concerns an aerosol generating device, such as an e-cigarette, comprising a heating element or an article as defined in the present application. The device may be an e-cigarette for example.

In embodiments the present invention concerns a method of generating an inhalable aerosol or vapor, wherein an article or a device as defined in the present application is provided and wherein the plate-shaped body of each heating element is heated to a predetermined temperature at the periphery of the opening so as to heat a vaporizable material provided to the heating elements to its vaporization temperature and form an inhalable aerosol.

In embodiments the predetermined temperature provided by the plate-shaped body of each heating element is a different temperature for each plate so that the temperature of the aerosol generated by heating of a vaporizable material provided to the heating elements and circulated inside the airflow path is adjustable.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate embodiments of the invention, and together with the general description given above and the detailed description given below, explain features of the invention.

FIG. 1 illustrates a top schematic view of a heating element according to an embodiment of the present invention.

FIGS. 2A to 2C illustrates embodiments of plate-shaped bodies according to the present invention.

FIG. 3 illustrates embodiments of a plate-shaped body with a mesh material according to the present invention.

FIGS. 4A-4D illustrate embodiments of means to attach mesh material to a plate-shaped body according to the present invention.

FIG. 5 illustrate an embodiment of a consumable article according to the present invention.

FIG. 6 illustrate another embodiment of a consumable article according to the present invention.

FIG. 7 illustrates an embodiment of an aerosol generating device according to the present invention.

FIG. 8 illustrates a block diagram showing a method of using an aerosol generating device according to the present invention.

In the present application, identical reference numerals are used, where possible, to designate identical elements that are common to the figures. Also, the drawings are simplified for illustration purposes and may not be depicted to scale.

### DETAILED DESCRIPTION OF SEVERAL EMBODIMENTS

In the following description, the principles the present invention will be detailed with reference to an e-cigarette, but they are not limited to this illustrative embodiment and applicable to other similar device which are suitable to use a consumable article with a vaporizable material.

The term vaporizable material is used to designate any material that is vaporizable at a temperature up to 400° C., preferably up to 350° C., for example aerosol generating liquid, gel, wax and the like.

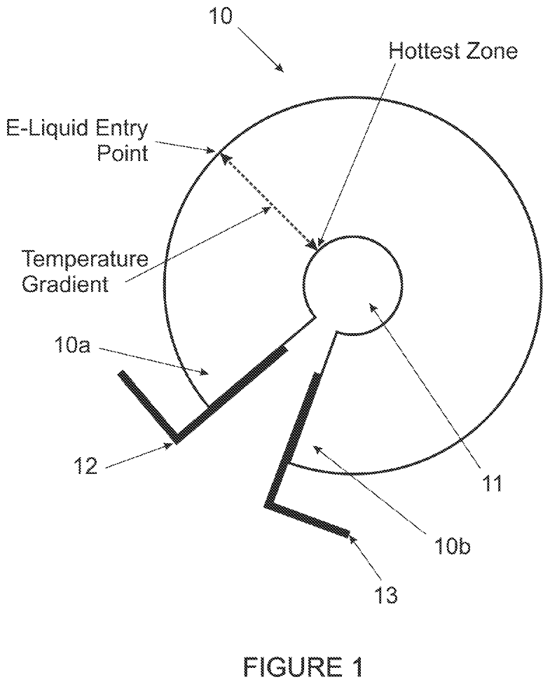

In an first embodiment represented in FIGS. 1 to 4a heating element for an aerosol-generating device or aerosol-generating consumable article, e.g. a cartomizer, according to the present application comprises a plate-shaped heating body 10 extending from a first end 10a to a second end 10b and having a general C-shape body 10 as shown in FIG. 1. The substantially circular shape of the body 10 as shown in FIG. 1 is only exemplary and other shapes (i.e. square or triangular) may be contemplated by a skilled person for the plate heating element 10 within the scope of the current invention. The body 10 comprises an opening 11 preferably placed at the center of the plate body. The body 10 further comprises contacts 12 and 13, reference 12 illustrating a negative contact and reference 13 illustrating a positive contact. The electrical contacts 12, 13 may be integral with the body 10 or may be attached and electrically connected to the body 10, such as at the ends 10a, 10b of the body 10. Alternatively, one contact 12 or 13 may be integral with the body 10 and the other contact 13 or 12 may be attached and electrically connected to the body 10. Also, reference 12 may illustrate the positive contact and reference 13 the negative contact.

According to the invention, the heating element 10 is configured to allow heating of a vaporizable material with a gradient of temperature from an entry point of contact of the vaporizable material with the body 10 towards an outlet point of contact at the central opening's rim 11a. In FIG. 1, such temperature gradient is schematically illustrated with the lowest temperature at the periphery of the disc plate which is also the entry point of the vaporizable material as marked in FIG. 1 and the hottest zone being around the opening 11 of the body 10.

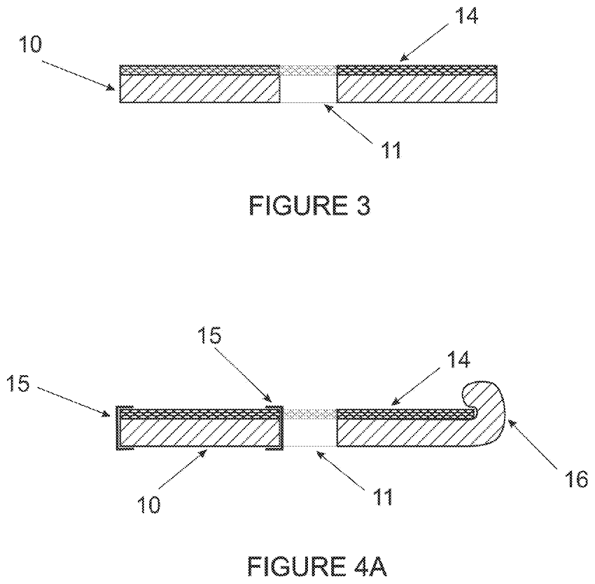

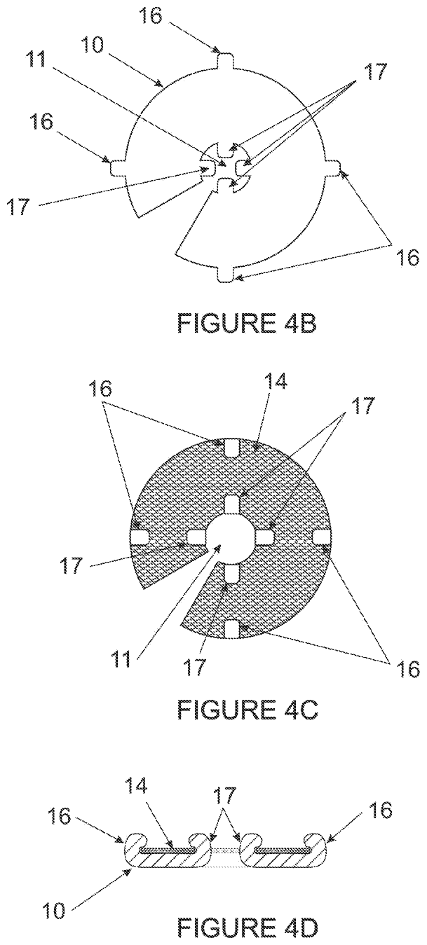

Preferably, a mesh is placed at least on one side of the body 10 as illustrated in FIGS. 3 and 4.

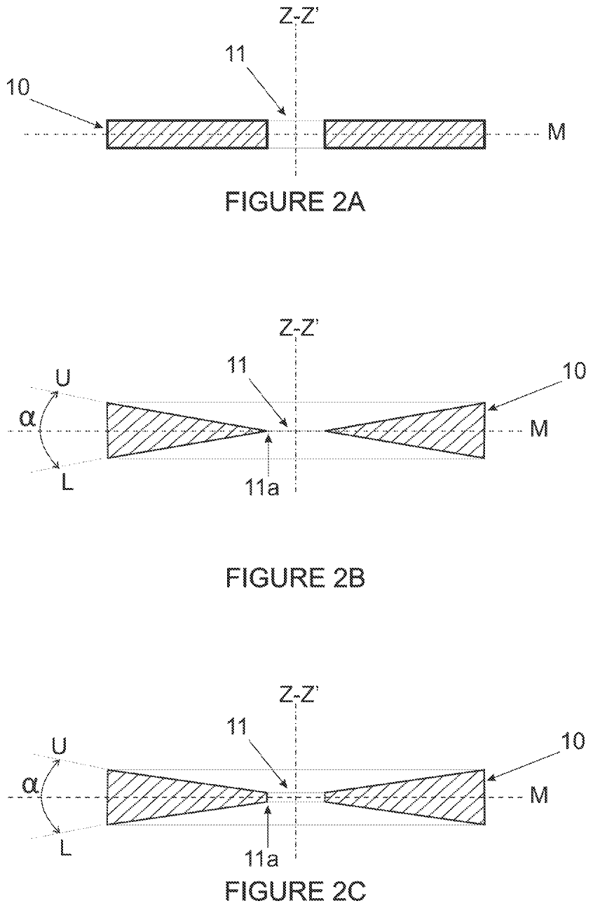

FIGS. 2A to 2C illustrates embodiment of the body 10 in cross-section. According to these exemplary embodiments, the body 10 seen in a transversal cross section taken along a central symmetry axis Z-Z′ passing through the centre of the opening 11 may present a different profile: for example in FIG. 2A, the profile has a constant thickness. In FIG. 2B, another profile is shown whereby the thickness gradually diminishes between the outer periphery 10c of the body 10 and the opening 11 to reach a sharp end forming a rim 11a of said opening 11. In FIG. 2C, another example is shown where the rim 11a is formed of a flat end and not a sharp one. Considering an angle α defined between a median plane M of the body 10 and a line parallel to the upper surface U or lower surface L of the disc intersecting the longitudinal axis Z-Z′ at the centre of the opening 11, the angle α will be in a range from about 5° to about 45°.

In all these embodiments, the transversal profile shape will have an effect on the heating time and the temperature gradient and said transversal profile shape may be adjusted to reach a desired effect, for example a heating time and/or temperature or performance.

FIG. 3 illustrates an example of a body 10 with a mesh 14 in a transversal cross-section according to embodiments of the present invention. The body 10 of this figure corresponds to the embodiment of FIG. 2A for illustrative purposes and the body 10 may also be as illustrated in FIGS. 2B or 2C or another body according to the present invention. The mesh 14 may be on one side of the body 10 or on both sides.

FIG. 4A illustrates a further embodiment of a heating element 1 according to the invention, whereby the mesh 14 is attached to the body 10 by means of fastening members. For example, such fastening members may comprise clips 15 as illustrated on the left side of the assembly of the body 10 and mesh 14, or lugs or ears 16 of the body 10 as schematically illustrated on the right side of the assembly body 10 and mesh 14. Lugs or ears 16 may be integrally formed with the heating plate-shaped body 10 and provide for example for crimping the mesh 14. The fastening members may be placed on the outer periphery 10c the body 10 and/or may be placed in the opening 11. In order to maintain the mesh 14 on the body 10, one may use a plurality of fastening members, for example at least three clips 15 placed around the periphery of the body and/or around the periphery of the opening 11. The same construction may be followed for ears 16. Alternative fastening members may of course also be used or combined with those previously described to allow proper attachment of the mesh 14 to the body 10.

FIGS. 4B illustrates a top view of a body 10 with ears 16 on the outer periphery of the plate and ears 17 on the periphery of the opening 11. In this example, four ears 16 and three ears 17 are illustrated but less than four/three or more than four/three may be used. Also, the numbers of ears 16 and 17 may be the same or different. The ears 16, 17 may be replaced by clips 15, or one may use a combination of clips 15 and ears 16, 17.

FIGS. 4C and 4D illustrate top view and side cut view of a body 10 with a mesh 14 that is fixed by the ears 16, 17. The opening 11 is illustrated as being disc-shaped in FIGS. 4B/4C but it may have another shape as illustrated in other figures of the present application.

According to the present invention, the body material and mesh material are chosen to sustain typical heating temperatures of heating elements used to vaporize aerosol-generating materials such as e-liquid, i.e. should not deform or be damaged/transformed up to temperatures of 400° C. to 500° C. Preferable materials for both the body 10 and mesh 14 may include metals, metal alloys, ceramics or combination therefrom. The heating body material may include a ceramic sintered material, such as alumina (Al203) and silicon nitride (S13N4), or printed circuit board or silicon rubber. It may alternatively comprise electrically resistive material among one or more of the following materials: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminum- titanium-zirconium-, hafnium-, niobium-, molybdenum-, tantalum-, tungsten-, tin-, gallium-and manganese-alloys, and super-alloys based on nickel, iron, cobalt, stainless steel.

The mesh 14 may also be formed of similar metallic material or non-metallic materials such as fiber, glass, aluminum, ceramic, glass fiber wick, stainless steel mesh for example.

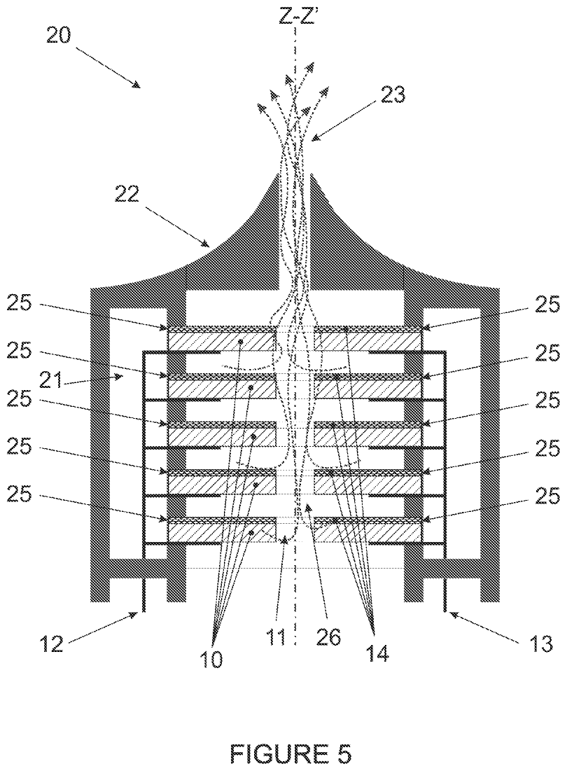

FIG. 5 illustrates an embodiment of a consumable article 20, such as a cartomizer, according to the present invention. The article 20 comprises a vaporizable material reservoir 21 with an outlet 25 and a plurality of bodies 10 (in FIG. 5 five plate-shaped bodies 10) as heating elements, an outlet 25 being provided for each body, the heating element being arranged with respect to the reservoir outlet forming an airflow channel 26 such that vaporizable material 21 exiting through the reservoir outlet 25 permeates through the mesh material towards the outer periphery of each plate-shaped body 10 and the airflow channel passes through the opening in the plate-shaped body 10. Of course, it is possible to use less than five bodies 10, that is a least one body 10 or more than five such bodies 10. The bodies 10 are arranged preferably parallel to each other and are connected to common electrical contacts 12, 13. The alignment of openings 11 of the bodies 10 along a longitudinal axis Z-Z′ of the cartomizer forms the airflow path 26 in which a vapor or aerosol 23 formed by heating of a vaporizable material provided to the bodies 10 from the vaporizable material reservoir 21 is directed into the mouthpiece 22 for inhalation by a user. The bodies 10 are fitted with mesh material 14 as illustrated in FIGS. 3 and 4A-4C for example, this construction extending to all configurations of bodies 10 in accordance with the principles of the present invention.

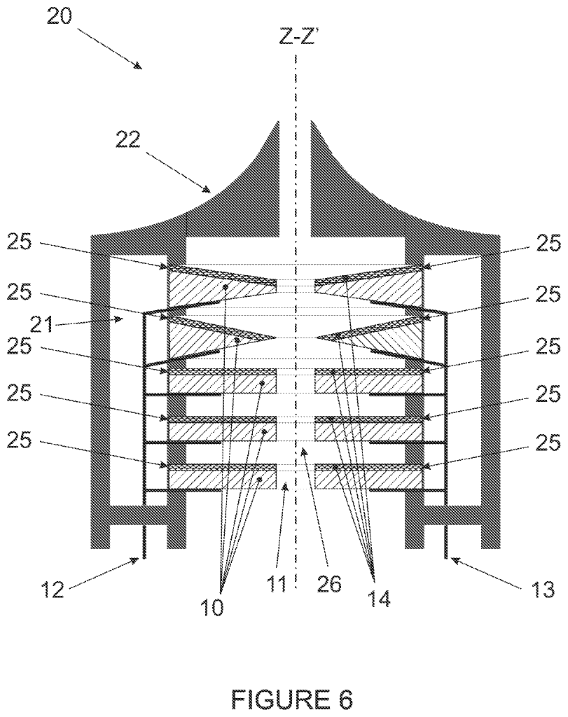

In FIG. 6, another embodiment of a consumable article according to the present invention is shown. This embodiment is similar to the one of FIG. 5 but differs in the profile of the individual bodies 10. As shown, they may have different profiles as illustrated in FIG. 2A to 2C for example. In this figure, the first body 10 on the proximal side (i.e. close to the mouthpiece 22) has the profile illustrated in FIG. 2C, the second body going downwards has the profile illustrated in FIG. 2B and the three last bodies on the distal end have the profile illustrated in FIG. 2A. Of course, this is only an example and all bodies 10 may have the same profile or a different one. Also the width of the airflow path may be constant from the distal side of the consumable article (away from the mouthpiece) to the proximal side of the consumable article (close to the mouthpiece) or it may change, for example increase from the distal side to the proximal side, or it may decrease from the distal side to the proximal side. This may be dependent on the profile of the bodies 10 or may be independent.

In the embodiment of FIG. 6, the different profiles of the bodies 10 may be used to manage the temperature around the openings 11 of each body 10 and therefore to vary the temperature along the airflow path.

A goal of this feature is

1) to adjust the temperature of the vapor exiting the mouthpiece in use
2) to ensure a better extract of flavors and constituents in the vapour channel
3) to control vapor droplets size by adjusting the temperature and controlling the condensation.

This can be achieved by selecting and arranging the bodies 10 in the consumable article so that a heating temperature profile along the air flow path in the article can be controlled. For example, to avoid particles condensation, one can choose to increase the temperature along the air flow channel, the proximal bodies 10 increasing progressively the temperature.

Alternatively, if one wants to reduce the vapor temperature, the proximal bodies will have a lower temperature than the distal bodies. A higher temperature in the middle portion of the article is likewise foreseeable increasing the temperature in the bodies arranged in such middle portion of the article. Preferably the temperature towards the opening 11 of each body shall be close to the boiling point of the vaporizable material provided to said body in the article. Accordingly, due to the temperature gradient, the vaporizable material is gradually vaporized until reaching the central (inner) zone of the disk. However, by exceeding the boiling point around about +10 to 20° C., the inner region will warm up the vapor.

For example, the temperature may be constant along the airflow path, or the temperature may increase or decrease from the distal side to the proximal side. In such case, the temperature of each body may increase, respectively decrease, or several bodies may have the same temperature.

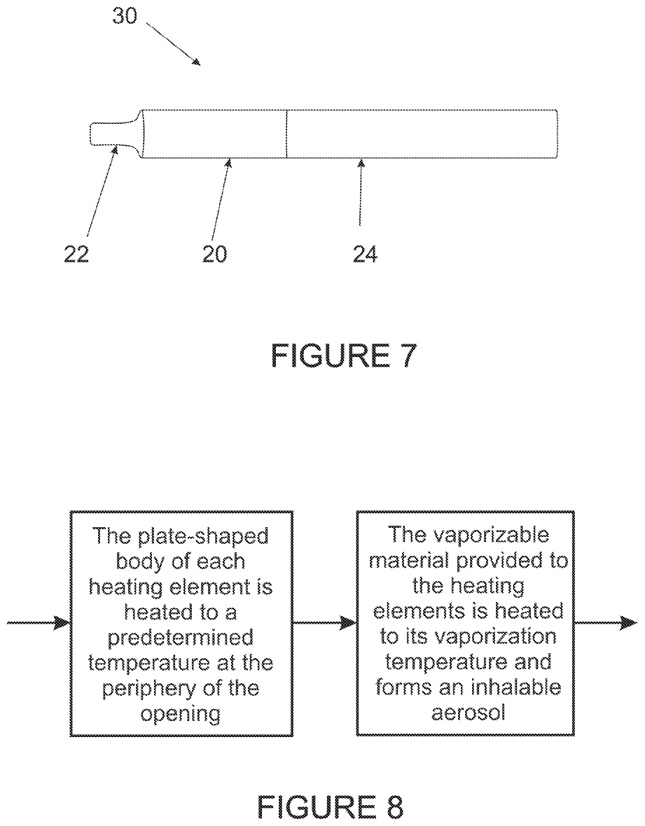

FIG. 7 schematically illustrates an embodiment of a vapor generating device according to the present invention. Generally, such a device 30 comprises a mouthpiece 22, a consumable article 20, such as a cartomizer (comprising a cartridge containing the vaporizable material 21), a heating element and a power supply or source 24. For example, such device may be an e-cigarette.

FIG. 8 illustrates in a block diagram the method of generating an inhalable aerosol or vapor with an article as defined herein is provided and wherein the plate-shaped body (10) of each heating element is heated to a predetermined temperature at the periphery of the opening (11) in such a way to heat a vaporizable material provided to the heating elements to its vaporisation temperature and form an inhalable aerosol. Different temperature for each plate can be set so that the temperature of the aerosol generated by heating of a vaporizable material provided to the heating elements and circulated inside the airflow path (23) is adjustable.

The present description is neither intended nor should it be construed as being representative of the full extent and scope of the present invention. The present invention is set forth in various levels of detail herein as well as in the attached drawings and in the detailed description of the invention and no limitation as to the scope of the present invention is intended by either the inclusion or non-inclusion of elements, components, etc. Additional aspects of the present invention have become more readily apparent from the detailed description, particularly when taken together with the drawings.

Moreover, exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with an exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with respect to embodiments of the present invention, the scope of the present invention is not so limited. Moreover, while this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A heating element (1) for an aerosol generating device, the heating element comprising a heating body (10) extending from a first end (10a) to a second end (10b) and provided with at least first and second electric contact parts (12, 13) wherein the heating body (10) is plate-shaped and comprises an opening (11) forming a substantially central airflow passage in the plate-shaped body (10); wherein the heating element is configured to provide a heating gradient between an outer periphery of the plate-shaped body (10) and the opening (11) therein;
wherein the heating element further comprises a mesh material (14) on at least one side of the plate-shaped body (10); and
wherein a thickness of the plate-shaped body (10) measured in a transversal cross-section thereof perpendicular to sides of the plate-shaped body is variable from the outer periphery of the plate to the opening (11), and gradually diminishes between the outer periphery and the opening (11).

2. The heating element according to claim 1, wherein the plate-shaped body (10) comprises means (15,16) for holding the mesh material (14), preferably ears or lugs extending from the body at its outer periphery

3. The heating element according to one of the preceding claims, wherein the plate-shaped body (10) is a disc.

4. The heating element according to any preceding claim, wherein a largest dimension of the opening (11) is at most equal to a width of the plate-shaped body (10), said width being measured from the outer periphery to an outer edge of the opening in a direction passing through the centre of the opening.

5. The heating element as defined in one of the preceding claims, wherein the plate-shaped body (10) is made of metal and the mesh material (14) is made of metal, sintered or not, such as nickel, nichrome, kanthal, tungsten, stainless steel.

6. A consumable article (20) for an aerosol generating device, the article comprising a reservoir for a vaporizable material (21), the reservoir having a material outlet (25), at least one heating element as defined in one of the preceding claims to heat vaporizable material exiting the reservoir through the reservoir outlet (25) to form an aerosol, and an airflow channel having an air inlet and an outlet for the aerosol generated through heating of the vaporizable material, wherein the heating element is arranged with respect to the reservoir outlet (25) and airflow channel such that vaporizable material (21) exiting through the reservoir outlet (25) permeates through the mesh material towards the outer periphery of the plate-shaped body (10) and the airflow channel passes through the opening in the plate-shaped body (10).

7. The article as defined in claim 6, wherein said article (20) comprises at least two heating elements arranged in series along a common longitudinal axis passing through the centre of each of the openings (11), wherein each plate-shaped body (10) of said heating elements is configured to provide a different heating temperature.

8. The article as defined in claim 6, wherein each plate-shaped body (10) has a different thickness.

9. The article as defined in the preceding claims 6 to 8, wherein said vaporizable material comprise e-liquid and/or wax and/or gel

10. An aerosol generating device (30) comprising a heating element as defined in one of claims 1 to 5 or an article (20) as defined in one of claims 6 to 9.

11. The aerosol generating device as defined in the preceding claim, wherein said device is an e-cigarette.

12. A method of generating an inhalable aerosol or vapor, wherein an article as defined in claims 6 to 9 or a device as defined in one of claim 10 or 11 is provided and wherein the plate-shaped body (10) of each heating element is heated to a predetermined temperature at the periphery of the opening (11) so as to heat a vaporizable material provided to the heating elements to its vaporisation temperature and form an inhalable aerosol.

13. The method according to the preceding claim, wherein the predetermined temperature provided by the plate-shaped body (10) of each heating element is a different temperature for each plate so that the temperature of the aerosol generated by heating of a vaporizable material provided to the heating elements and circulated inside the airflow path (23) is adjustable.
